(19) United States
(12) Patent Application Publication
(10) Pub. No.: US 2023/0395051 A1
(43) Pub. Date: Dec. 7, 2023

(54) PITCH ADJUSTMENT METHOD AND DEVICE, AND COMPUTER STORAGE MEDIUM

(71) Applicant: Tencent Music Entertainment Technology (Shenzhen) Co., Ltd., Shenzhen (CN)

(72) Inventors: Yu Zhou, Shenzhen (CN); Sen Lin, Shenzhen (CN)

(73) Assignee: Tencent Music Entertainment Technology (Shenzhen) Co., Ltd., Shenzhen (CN)

(21) Appl. No.: 18/034,031

(22) PCT Filed: Sep. 22, 2021
(86) PCT No.: PCT/CN2021/119571

§ 371 Date: Apr. 26, 2023

(30) Foreign Application Priority Data
Oct. 27, 2020 (CN) 202011163021.7

(51) Int. Cl. G10H 1/36; G10H 1/00

(52) U.S. Cl. CPC G10H 1/366; G10H 1/0008; G10H 2210/066; G10H 2210/331; G10H 2210/005

(57) ABSTRACT

A pitch adjustment method and apparatus, and a computer storage medium are provided. the fundamental frequency sequence of the singing sound of the user is obtained, the pitch difference between each candidate melody file and the fundamental frequency sequence at each corresponding time point is calculated, and the sum of all pitch differences of each candidate melody file is calculated. The candidate melody file with the minimum sum is determined as the target melody file, and the pitch of the accompaniment file of the target song is adjusted according to the pitch difference between the target melody file and the original melody file of the target song.

The present application claims priority to Chinese Patent Application No. 202011163021.7, titled “PITCH ADJUSTMENT METHOD AND DEVICE, AND COMPUTER STORAGE MEDIUM”, filed on Oct. 27, 2020 with the National Intellectual Property Administration, PRC, which is incorporated herein by reference in its entirety.

### FIELD

The present disclosure relates to the technical field of data processing, and in particular to a pitch adjustment method and apparatus, and a computer storage medium.

### BACKGROUND

At present, the music software on intelligent terminals may provide users with song recording services, that is, the music software plays an accompaniment of a song, the user sings under the accompaniment, and the music software records the singing sound of the user, and mixes the singing sound of the user with the accompaniment of the song, to obtain a final work, which includes both the singing sound of the user and the accompaniment of the song.

Due to their own pronunciation limitations, some users cannot sing the high-pitched or low-pitched parts of the song. Therefore, even if the music software provides a reference pitch of a current accompaniment, due to their own pronunciation limitations, the users still cannot sing accurately according to the reference pitch. In this case, the user may manually adjust the pitch of the accompaniment to make it match his own pronunciation, that is, if the user cannot sing the high-pitched part, the user may manually lower the pitch of the accompaniment.

However, if the user does not manually adjust the pitch of the accompaniment, the pitch of the singing sound of the user will be inconsistent with that of the accompaniment in the final work, which seriously affects the sense of listening of the work. If the user needs to adjust the pitch of the accompaniment according to his own pronunciation each time he sings, this also brings inconvenience to the user when using the music software, affecting the user experience.

### SUMMARY

A pitch adjustment method and apparatus, and a computer storage medium are provided according to embodiments of the present disclosure, which are used to automatically adjust an accompaniment of a target song, to enable a singing sound of a user to match the accompaniment in pitch.

In a first aspect of the embodiments of the present disclosure, a pitch adjustment method is provided, which includes:
obtaining multiple candidate melody files, where each of the candidate melody files is used to identify a pitch of each note in a melody of a target song, and pitches identified by the candidate melody files are different from each other;
obtaining a fundamental frequency sequence of a singing sound of a user for singing the target song, and converting a frequency at a target fundamental frequency point of the fundamental frequency sequence into a pitch according to a preset algorithm, where the target fundamental frequency point includes a fundamental frequency point corresponding to a note of the candidate melody file in time in the fundamental frequency sequence;
calculating a pitch difference between each of the candidate melody files and the fundamental frequency sequence at each corresponding time point, and calculating a sum of all pitch differences of each of the candidate melody files; and
determining a candidate melody file with a minimum sum as a target melody file, and adjusting a pitch of an accompaniment file of the target song according to a pitch difference between the target melody file and an original melody file of the target song.

In a second aspect of the embodiments of the present disclosure, a pitch adjustment apparatus is provided, which includes: a first obtaining unit, a second obtaining unit, a conversion unit, a calculation unit, and a pitch adjustment unit. The first obtaining unit is configured to obtain multiple candidate melody files, where each of the candidate melody files is used to identify a pitch of each note in a melody of a target song, and pitches identified by the candidate melody files are different from each other. The second obtaining unit is configured to obtain a fundamental frequency sequence of a singing sound of a user for singing the target song. The conversion unit is configured to convert a frequency at a target fundamental frequency point of the fundamental frequency sequence into a pitch according to a preset algorithm, where the target fundamental frequency point includes a fundamental frequency point corresponding to a note of the candidate melody file in time in the fundamental frequency sequence. The calculation unit is configured to calculate a pitch difference between each of the candidate melody files and the fundamental frequency sequence at each corresponding time point, and determining a sum of all pitch differences of each of the candidate melody files. The pitch adjustment unit is configured to a candidate melody file with a minimum sum as a target melody file, and adjust a pitch of an accompaniment file of the target song according to a pitch difference between the target melody file and an original melody file of the target song.

In a third aspect of the embodiments of the present disclosure, a pitch adjustment apparatus is provided, which includes: a processor, a memory, a bus, and input and output devices. The processor is connected to the memory and the input and output devices. The bus is connected to the processor, the memory and the input and output devices. The processor is configured to: obtain multiple candidate melody files, where each of the candidate melody files is used to identify a pitch of each note in a melody of a target song, and pitches identified by the candidate melody files are different from each other; obtain a fundamental frequency sequence of a singing sound of a user for singing the target song, and convert a frequency at a target fundamental frequency point of the fundamental frequency sequence into a pitch according to a preset algorithm, where the target fundamental frequency point includes a fundamental frequency point corresponding to a note of the candidate melody file in time in the fundamental frequency sequence; calculate a pitch difference between each of the candidate melody files and the fundamental frequency sequence at each corresponding time point, and determining a sum of all pitch differences of each of the candidate melody files; and determine a candidate melody file with a minimum sum as a target melody file, and adjust a pitch of an accompaniment file of the target song according to a pitch difference between the target melody file and an original melody file of the target song.

In a fourth aspect of the embodiments of the present disclosure, a computer storage medium is provided, which stores instructions. The instructions, when executed on a computer, cause the computer to execute the method according to the first aspect.

It can be seen from the above technical solutions that the embodiments of the present disclosure have the following advantages. In the embodiments of the present disclosure, the fundamental frequency sequence of the singing sound of the user is obtained, the pitch difference between each candidate melody file and the fundamental frequency sequence at each corresponding time point is calculated, and the sum of all pitch differences of each candidate melody file is calculated. The candidate melody file with the minimum sum is determined as the target melody file, and the pitch of the accompaniment file of the target song is adjusted according to the pitch difference between the target melody file and the original melody file of the target song. In this way, since the pitch identified by the target melody file has the highest matching degree with the pitch of the singing sound of the user, the pitch of adjusted accompaniment can match the pitch of the singing sound of the user, and the final mixed work has a good experience of listening.

### BRIEF DESCRIPTION OF THE DRAWINGS

FIG. 1 is a schematic flow chart of a pitch adjustment method according to an embodiment of the present disclosure;

FIG. 2 is a schematic flow chart of a pitch adjustment method according to another embodiment of the present disclosure;

FIG. 3 is a schematic structural diagram of a pitch adjustment apparatus according to an embodiment of the present disclosure;

FIG. 4 is a schematic structural diagram of a pitch adjustment apparatus according to another embodiment of the present disclosure; and

FIG. 5 is a schematic structural diagram of a pitch adjustment apparatus according to another embodiment of the present disclosure.

### DETAILED DESCRIPTION OF EMBODIMENTS

A pitch adjustment method and apparatus, and a computer storage medium are provided according to embodiments of the present disclosure, which are used to automatically adjust an accompaniment of a target song, to enable a singing sound of a user to match the accompaniment in pitch.

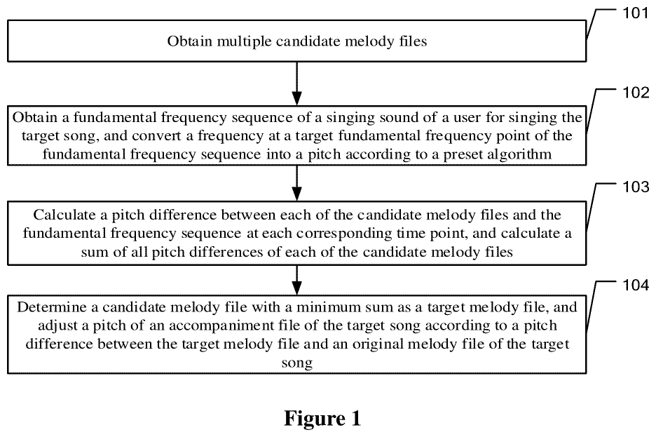

Referring to FIG. 1, a pitch adjustment method is provided according to an embodiment of the present disclosure, which includes the following steps 101 to 104.

In step 101, multiple candidate melody files are obtained.

The method of the embodiment may be applied to a pitch adjustment apparatus, which may be a computer device capable of performing data processing tasks, such as a terminal and a server. If the pitch adjustment apparatus is a terminal, the pitch adjustment apparatus may be a smart phone, a tablet computer, a laptop computer, a desktop computer, a self-service terminal, etc. If the pitch adjustment apparatus is a server, the pitch adjustment apparatus may be an independent physical server, a server cluster or a distributed system composed of multiple physical servers, or a cloud server that provides basic cloud computing services such as cloud databases, cloud computing, big data, artificial intelligence platforms, etc.

In the embodiment, a pitch of an accompaniment of a target song is adjusted according to a pitch of a singing sound of a user, so that the pitch of the accompaniment matches the pitch of the singing sound of the user, and the mixed work of the singing sound of the user and the accompaniment has a good sense of listening. Based on the above principles, when adjusting the pitch of the accompaniment of the target song, multiple candidate melody files are used as references to determine an adjustment degree of the pitch of the accompaniment. Therefore, in order to adjust the pitch of the accompaniment, multiple candidate melody files are obtained, each candidate melody file is used to identify a pitch of each note in the melody of the target song, and the pitches identified by the candidate melody files are different from each other.

For a 108-key piano, the pitch ranges from 0 to 108; for an 88-key piano, the pitch ranges from 0 to 88. Therefore, a pitch of a melody of a target song identified by a candidate melody file may be a pitch of 0 to 108 or 0 to 88. For example, a pitch identified by a candidate melody file 1 is 0, a pitch identified by a candidate melody file 2 is 1, and so on.

In step 102, a fundamental frequency sequence of a singing sound of a user for singing a target song is obtained, and a frequency at a target fundamental frequency point of the fundamental frequency sequence is converted into a pitch according to a preset algorithm.

When the user sings the target song, the singing sound of the user is collected, and the pitch adjustment apparatus obtains audio data of the singing sound of the user, and extracts the fundamental frequency of the singing sound to obtain a fundamental frequency sequence, which includes multiple fundamental frequency points. In the embodiment, there may be multiple methods for extracting the fundamental frequency of the singing sound. For example, the commonly used fundamental frequency extraction algorithms include an autocorrelation algorithm, a parallel processing method, a cepstrum method and a simplified inverse filtering method. The fundamental frequency of the singing sound may be extracted by using the above-mentioned algorithm, to obtain the fundamental frequency sequence of the singing sound of the user.

In the embodiment, since multiple candidate melody files are used as references, and each of the multiple candidate melody files is used to identify a pitch of a melody, when comparing each of the candidate melody files with the fundamental frequency sequence of the singing sound of the user, it is required to convert a frequency at a target fundamental frequency point of the fundamental frequency sequence into a pitch, and the target fundamental frequency point includes a fundamental frequency point corresponding to the note of the candidate melody file in time in the fundamental frequency sequence. In this way, the pitch at the fundamental frequency point is compared with the pitch identified by the candidate melody file, and the comparison result may be used as a reference for adjusting the pitch of the accompaniment.

In step 103, a pitch difference between each of the candidate melody files and the fundamental frequency sequence at each corresponding time point is calculated, and a sum of all pitch differences of each candidate melody file is calculated.

Since the melody is composed of notes, the pitch identified by the candidate melody file includes the pitch of the note. After converting the frequency at each fundamental frequency point of the fundamental frequency sequence into a pitch, the pitch difference between each candidate melody file and the fundamental frequency sequence at each corresponding time point may be calculated, where the corresponding time point refers to that the fundamental frequency point of the fundamental frequency sequence falls within a time range of a certain note in the candidate melody file, so that the fundamental frequency point corresponds to the note in time. For example, a time of a note is 1 s, if a fundamental frequency point falls within the time range of the note at the time of 1 s, the fundamental frequency point corresponds to the note in time, and the pitch difference between the fundamental frequency point and the note may be calculated.

After the pitch difference at each corresponding time point is calculated, all the pitch differences of each candidate melody file are accumulated, to obtain a sum of the pitch differences of each candidate melody file. The sum of the pitch differences may reflect a difference between the pitch of the candidate melody file and the pitch of the fundamental frequency sequence of the singing sound of the user, that is, a large sum reflects a large difference, which indicates that the pitch of the candidate melody file is not fit the pitch of the singing sound of the user; and a small sum reflects a small difference, which indicates that the pitch of the candidate melody file fits the pitch of the singing sound of the user. Therefore, the pitch of the accompaniment is adjusted according to the candidate melody file, and an accompaniment matching the pitch of the singing sound of the user may be obtained.

In step 104, a candidate melody file with a minimum sum is determined as a target melody file, and a pitch of an accompaniment file of the target song is adjusted according to a pitch difference between the target melody file and an original melody file of the target song.

In view of the above analysis, a small sum of the pitch differences of the candidate melody file is beneficial to adjust the pitch of the accompaniment. Therefore, after obtaining the sum of the pitch differences of each candidate melody file, the candidate melody file with a minimum sum of pitch differences is determined as the target melody file, which may be used as a reference to adjust a pitch of an accompaniment.

In the embodiment, the original melody file of the target song is used to identify a pitch of a note in an original melody of the target song, and the original melody may be a singing melody of an original singer of the target song. As the original singer is generally professional, the pitch of the original melody generally matches the pitch of the accompaniment of the target song, and the pitch identified by the original melody file also matches the pitch of the accompaniment. Therefore, the pitch of the accompaniment file of the target song may be adjusted according to the pitch difference between the target melody file and the original melody file. Since the pitch identified by the target melody file matches the pitch of the fundamental frequency sequence of the singing sound of the user, the accompaniment obtained by adjusting the pitch according to the target melody file matches the pitch of the singing sound of the user, so that a mixed work formed by the adjusted accompaniment and the singing sound of the user has a good sense of listening.

For example, if pitches of notes identified by a candidate melody file are 24, 25, 29, 31, 34, and 27 (in practice, the number of notes identified by the candidate melody file is determined according to the target song, here only a limited number of notes are exemplified), and the pitches at the target fundamental frequency points corresponding to the above notes in the fundamental frequency sequence of the target song are 24, 25, 28, 31, 34, 27. The pitch differences between the target fundamental frequency points and the corresponding notes are calculated as 0, 0, 1, 0, 0, 0 (an absolute value is used for the pitch difference), and the sum of the pitch differences is 1. By analogy, the sum of pitch differences of other candidate melody files may be calculated.

Assuming that there are 12 candidate melody files, the sums of the pitch differences are 137, 109, 90, 73, 49, 24, 1, 22, 45, 67, 86, 114, a candidate melody file with a pitch difference of 1 is determined as the target melody file. Assuming that the target melody file and the original melody file of the target song differ in pitch by two semitones, the pitch of the accompaniment file of the target song may be adjusted according to the pitch difference between the target melody file and the original melody file of the target song, so that the adjusted accompaniment match the pitch of the singing sound of the user, improving the sense of listening.

In the embodiment, the fundamental frequency sequence of the singing sound of the user is obtained, the pitch difference between each candidate melody file and the fundamental frequency sequence at each corresponding time point is calculated, the sum of the pitch differences of each candidate melody file is calculated, and the candidate melody file with the minimum sum is determined as the target melody file, and the pitch of the accompaniment file of the target song is adjusted according to the pitch difference between the target melody file and the original melody file of the target song. Since the pitch identified by the target melody file has the highest matching degree with the pitch of the singing sound of the user, the adjusted accompaniment matches the pitch of the singing sound of the user, and the mixed work has a good sense of listening.

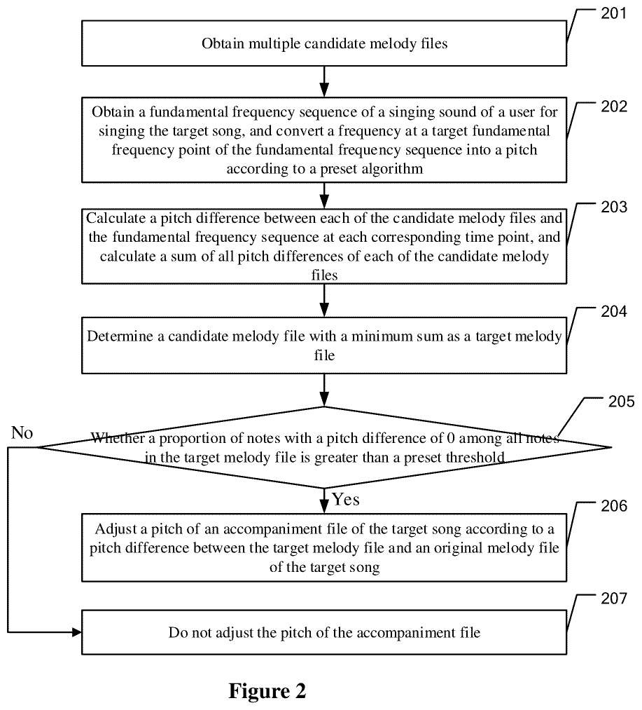

Next, the embodiment of the present disclosure is further described in detail in the following on the basis of the foregoing embodiment shown in FIG. 1. Referring to FIG. 2, a pitch adjustment method according to another embodiment of the present disclosure includes the following steps 201 to 207.

In step 201, multiple candidate melody files are obtained.

In the embodiment, the multiple candidate melody files may be any files used to identify the pitch of the melody of the target song, as long as the pitches identified by the candidate melody files are different from each other.

In a preferred embodiment, the multiple candidate melody files may be obtained by converting the original melody file of the target song. Similarly, the original melody file is used to identify the pitch of the original melody of the target song, and the original melody may be a singing melody of the original singer of the target song. Since the melody is composed of notes, when converting the original melody file by rising or falling the pitch, a conversion value may be added to the pitches of all the notes in the original melody file, to obtain the converted melody file. Therefore, the converted melody file and the original melody file may be both used as candidate melody files, and both may be used as references for adjusting the pitch of the accompaniment.

It is to be understood that, since the conversion of the original melody file may be a conversion of pitch rising or a conversion of pitch falling, the conversion value may be positive or a negative. For example, if the conversion value is +1, it indicates that the pitch of the original melody file is increased by 1 unit, which represents a conversion of pitch rising; if the conversion value is −2, it indicates that the pitch of the original melody file is decreased by 2 units, which represents a conversion of pitch falling.

In the embodiment, when converting the original melody file, the conversion may be performed based on the principle of the 12-equal temperament. The 12-equal temperament is a method of music law, which divides a pure octave into twelve equal parts, and each part is called a semitone, the 12-equal temperament is the most important tuning method. Therefore, based on the 12-equal temperament, an octave of the original melody file may be equally divided to obtain twelve semitone intervals, where the original melody file corresponds to one of the twelve semitone intervals. Then, according to the interval relationship between the semitone interval corresponding to the original melody file and other semitone intervals, the pitch of each note in the original melody file is added by a conversion value until the adding is performed for 11 number of times, thereby obtaining 11 converted melody files. Since adding the conversion value is performed according to the semitone interval, the converted melody file also corresponds to one of the twelve semitone intervals, that is, each converted melody file corresponds to one of the twelve semitone intervals. The 11 converted melody files together with the original melody file form 12 candidate melody files.

For example, the pitch of each note in the original melody file is added by a conversion value until the adding is performed for 11 number of times, that is, respectively adding +1, +2, +3, . . . , +9, +10, +11 to the pitch of each note in the original melody file, therefore, the pitch of the original melody file is the minimum, and the pitch of the melody file obtained by adding the conversion value of +11 is maximum.

In step 202, a fundamental frequency sequence of a singing sound of a user for singing a target song is obtained, and a frequency at a target fundamental frequency point of the fundamental frequency sequence is converted into a pitch according to a preset algorithm.

In the embodiment, the specific algorithm content of the preset algorithm is not limited, as long as the algorithm is capable of converting the frequency at the fundamental frequency point into a pitch. For example, the preset algorithm may be implemented as the following formula:

PITCH=12*log 2(hz_value/440.0)+69
where hz_value is the frequency at the fundamental frequency point. The frequency at the fundamental frequency point may be converted into a pitch according to the above formula.

In the embodiment, the target fundamental frequency points may include all the fundamental frequency points in the fundamental frequency sequence, or may only include the target fundamental frequency points corresponding to the notes of the candidate melody file in time. The pitch at the target fundamental frequency point may be calculated in the following two ways. In one way, fundamental frequency points of the fundamental frequency sequence may be traversed, the frequency at each fundamental frequency point is converted into a pitch according to the preset algorithm, and the target fundamental frequency point corresponding to the note of the melody file in time is determined from all the fundamental frequency points of the fundamental frequency sequence. In another way, the target fundamental frequency point corresponding to the note of the candidate melody file in time is determined from all the fundamental frequency points of the fundamental frequency sequence, and only the frequency at the target fundamental frequency point is converted into a pitch. Compared with the former way, it is unnecessary to perform conversion on frequencies of other fundamental frequency points, greatly reducing the operations of calculating the pitch, thus reducing the pressure in data processing.

In step 203, a pitch difference between each candidate melody file and the fundamental frequency sequence at each corresponding time point is calculated, and a sum of all pitch differences of each candidate melody file is calculated.

In the embodiment, in order to calculate the pitch difference between each candidate melody file and the fundamental frequency sequence at each corresponding time point, the pitch of the note corresponding to the target fundamental frequency point in time in each candidate melody file is obtained, that is, when a fundamental frequency point falls within a time range of a note, the fundamental frequency point is the target fundamental frequency point corresponding to the note in time. Then, the pitch difference between the target fundamental frequency point and the note corresponding to the target fundamental frequency point in time is calculated, to obtain the pitch difference between the candidate melody file and the fundamental frequency sequence at each corresponding time point.

It is determined whether the note in the candidate melody file corresponds to the fundamental frequency point of the fundamental frequency sequence in time in a way that the candidate melody file further identifies a start time and an end time of the note in the melody of the target song, and the note corresponding to the target fundamental frequency point in time may be determined according to the start time and end time of the note, that is, if the fundamental frequency point falls within the time period from a start time to an end time of a note, the target fundamental frequency is determined to be corresponding to the note in time. In a case that the corresponding note is determined, the pitch of the note is obtained.

After calculating the pitch differences of all corresponding time points of each candidate melody file, all the pitch differences of each candidate melody file are accumulated, to obtain the sum of the pitch differences of each candidate melody file.

In step 204, the candidate melody file with a minimum sum is determined as the target melody file.

The candidate melody file with the minimum sum of pitch differences has the highest pitch matching degree with the singing sound of the user, therefore, the candidate melody file with the minimum sum of pitch differences is determined as the reference for adjusting the pitch of the accompaniment.

In step 205, it is determined whether a proportion of notes with a pitch difference of 0 among all notes in the target melody file is greater than a preset threshold. If the proportion of notes with a pitch difference of 0 among all notes in the target melody file is greater than a preset threshold, step 206 is performed, and if the proportion of notes with a pitch difference of 0 among all notes in the target melody file is not greater than a preset threshold, step 207 is performed.

In the embodiment, after the target melody file is determined, the pitch matching degree between the target melody file and the singing sound of the user may further be determined. That is, a large proportion of notes with a pitch difference of 0 among all notes in the target melody file indicates the pitch difference between the target melody file and the singing sound of the user is small and the matching degree is high.

For example, if the proportion of notes with a pitch difference of 0 among all notes in the target melody file is 100%, it indicates that there is no pitch difference between the entire target melody file and the singing sound of the user, and the pitch identified by the target melody file matches the singing sound of the user, which also shows that the user has a strong ability to follow the pitch from another perspective. Conversely, if the proportion of notes with a pitch difference of 0 among all notes in the target melody file is extremely low, it indicates that there are many differences in pitch between the target melody file and the singing sound of the user, and the matching degree between the target melody file and the singing sound of the user is low. This may be caused by the reason that the user does not has a strong ability to follow the pitch and often goes out of tune when singing, and thus the user cannot sing at a certain pitch.

The preset threshold may be set according to actual needs. Specifically, the preset threshold may be set based on experimental data, for example, the preset threshold may be set as any value between 80% and 100%.

In step 206, a pitch of an accompaniment file of the target song is adjusted according to a pitch difference between the target melody file and an original melody file of the target song.

When the proportion of notes with a pitch difference of 0 among all notes in the target melody file is greater than the preset threshold, it indicates that the target melody file has a high matching degree in pitch with the singing sound of the user, and the pitch of the accompaniment file of the target song is adjusted according to the pitch difference between the target melody file and the original melody file of the target song. The operations performed in this step are similar to the operations performed in step 104 in the foregoing embodiment shown in FIG. 1.

The target melody file is one of multiple candidate melody files obtained in step 201, if the multiple candidate melody files are obtained by converting the original melody file of the target song, the pitch difference between the target melody file and the original melody file may be determined directly according to a conversion relationship between the target melody file and the original melody file.

Specifically, in step 201, since the original melody file is converted based on the 12-equal temperament to obtain 12 candidate melody files and each candidate melody file corresponds to a semitone interval, there is an interval relationship between the target melody file and the original melody file, that is, how many semitones are there between the target melody file and the original melody file. When the interval relationship is specifically expressed in pitch, it indicates the pitch difference between the melody corresponding to the target melody file and the melody corresponding to the original melody file. Therefore, the pitch of the accompaniment file of the target song may be adjusted according to the interval relationship between the target melody file and the original melody file.

In step 207, the pitch of the accompaniment file is not adjusted.

When the proportion of notes with a pitch difference of 0 among all notes in the target melody file is less than the preset threshold, it indicates that there are many differences in pitch between the target melody file and the singing sound of the user, and the matching degree between the target melody file and the singing sound of the user is low. In this case, it is considered that the user has a poor ability to follow the pitch of the target song, even if the pitch of the accompaniment file is adjusted according to the target melody file, the accompaniment still cannot match the singing sound of the user well. Therefore, the pitch of the accompaniment file is not adjusted, and thus the pitch of the accompaniment is not changed.

In the embodiment, it is determined whether the proportion of notes with a pitch difference of 0 among all notes in the target melody file is greater than a preset threshold, to further determine the matching degree in pitch between the target melody file and the singing sound of the user, which improves the feasibility of the solution.

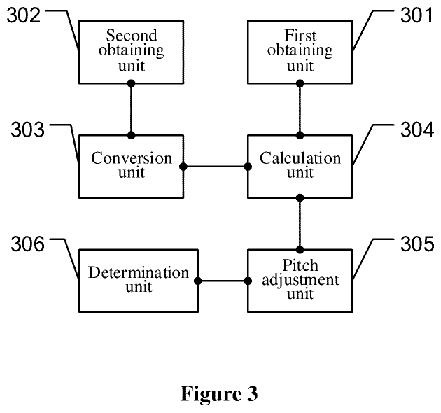

The pitch adjustment method is described according to the above embodiment of the present disclosure, and the pitch adjustment apparatus according to an embodiment of the present disclosure is described below. Referring to FIG. 3, the pitch adjustment apparatus according to an embodiment of the present disclosure includes: a first obtaining unit 301, a second obtaining unit 302, a conversion unit 303, a calculation unit 304, and a pitch adjustment unit 305. The first obtaining unit 301 is configured to obtain multiple candidate melody files, and each of the candidate melody files is used to identify a pitch of each note in a melody of a target song, and pitches identified by the candidate melody files are different from each other. The second obtaining unit 302 is configured to obtain a fundamental frequency sequence of a singing sound of a user for singing the target song. The conversion unit 303 is configured to convert a frequency at a target fundamental frequency point of the fundamental frequency sequence into a pitch according to a preset algorithm, and the target fundamental frequency point includes a fundamental frequency point corresponding to the note of the candidate melody file in time in the fundamental frequency sequence. The calculation unit 304 is configured to calculate a pitch difference between each candidate melody file and the fundamental frequency sequence at each corresponding time point, and determine a sum of all pitch differences of each candidate melody file. The pitch adjustment unit 305 is configured to determine a candidate melody file with a minimum sum as a target melody file, and adjust a pitch of an accompaniment file of the target song according to a pitch difference between the target melody file and an original melody file of the target song.

In a preferred implementation of the embodiment, the first obtaining unit 301 is further configured to obtain the original melody file of the target song; add a conversion value to a pitch of each note in the original melody file to obtain a converted melody file; and determine the original melody file and the converted melody file as the candidate melody files.

In a preferred implementation of the embodiment, the first obtaining unit 301 is further configured to equally divide, based on the 12-equal temperament, an octave corresponding to the original melody file to obtain twelve semitone intervals, where the original melody file corresponds to one of the twelve semitone intervals; and add, based on an interval relationship between the semitone interval corresponding to the original melody file and other semitone intervals, the conversion value to the pitch of each note in the original melody file until the adding is performed for eleven number of times, to obtain eleven converted melody files. Each of the converted melody files corresponds to one of the twelve semitone intervals.

In a preferred implementation of the embodiment, in a case that the target melody file is not the original melody file, the pitch adjustment unit 305 is further configured to adjust the pitch of the accompaniment file of the target song according to the interval relationship between the target melody file and the original melody file.

In a preferred implementation of the embodiment, the pitch adjustment apparatus further includes: a determination unit 306, configured to determine whether a proportion of notes with a pitch difference of 0 among all notes in the target melody file is greater than a preset threshold. The pitch adjustment unit 305 is further configured to perform the step of adjusting a pitch of an accompaniment file of the target song according to a pitch difference between the target melody file and an original melody file of the target song if the proportion of the notes with the pitch difference of 0 among all notes in the target melody file is greater than the preset threshold; and perform no adjustment on the pitch of the accompaniment file if the proportion of the notes with the pitch difference of 0 among all notes in the target melody file is not greater than the preset threshold.

In a preferred implementation of the embodiment, the conversion unit 303 is further configured to traverse fundamental frequency points of the fundamental frequency sequence, convert the frequency at each fundamental frequency point into a pitch according to the preset algorithm, and determine the target fundamental frequency point corresponding to the note of the melody file in time from all the fundamental frequency points of the fundamental frequency sequence. The calculation unit 304 is further configured to obtain the pitch of the note corresponding to the target fundamental frequency point in time in each candidate melody file, and calculate the pitch difference between the target fundamental frequency point and the note corresponding to the target fundamental frequency point in time.

In a preferred implementation of the embodiment, the candidate melody file is also used to identify a start time and an end time of each note in the melody of the target song. The calculation unit 304 is further configured to determine the note corresponding to the target fundamental frequency point in time according to the start time and the end time of the note in each candidate melody file, and obtain the pitch of the note corresponding to the target fundamental frequency point in time.

In the embodiment, the operations performed by each unit in the pitch adjustment apparatus are similar to those described in the foregoing embodiment shown in FIGS. 1 to 2, and will not be repeated here.

In the embodiment, the first obtaining unit 301 obtains the fundamental frequency sequence of the singing sound of the user, and the calculation unit 304 calculates the pitch difference between each candidate melody file and the fundamental frequency sequence at each corresponding time point, and calculate the sum of all pitch differences of each candidate melody file, the pitch adjustment unit 305 determines the candidate melody file with the minimum sum as the target melody file, and adjusts the pitch of the accompaniment file of the target song according to the pitch difference between the target melody file and the original melody file of the target song. Since the pitch identified by the target melody file matches the pitch of the singing sound of the user, the adjusted accompaniment matches the pitch of the singing sound of the user, and the mixed work has a good sense of listening.

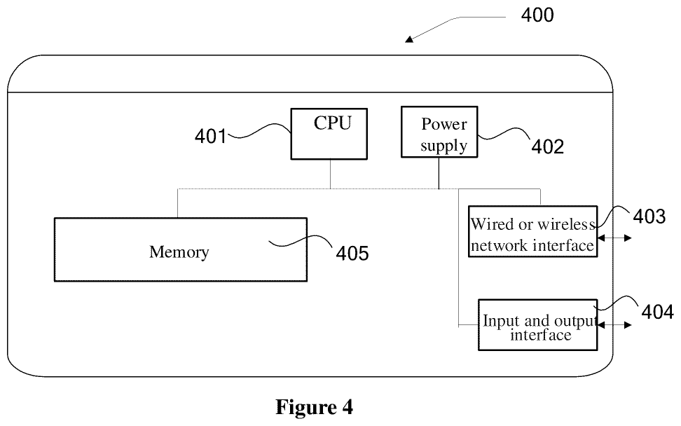

A pitch adjustment apparatus according to an embodiment of the present disclosure is described below. In a case that the pitch adjustment apparatus is a server, the structural diagram is as shown in FIG. 4. Referring to FIG. 4, according to the embodiment of the present disclosure, the pitch adjustment apparatus 400 may include one or more central processing units (CPU) 401 and a memory 405, the memory 405 stores one or more application programs or data. The memory 405 may be a volatile memory or a persistent memory. The program stored in the memory 405 may include one or more modules, and each module may include a series of instruction operations on the pitch adjustment apparatus. Furthermore, the central processing unit 401 may be configured to communicate with the memory 405, and execute a series of instruction operations in the memory 405 on the pitch adjustment apparatus 400.

The pitch adjustment apparatus 400 may further include one or more power supplies 402, one or more wired or wireless network interfaces 403, one or more input and output interfaces 404, and/or one or more operating systems, such as Windows Server™, Mac OS X™, Unix™, Linux™, and FreeBSD™.

The central processing unit 401 may perform the operations performed by the pitch adjustment apparatus in the aforementioned embodiment shown in FIGS. 1 to 2, and the details will not be repeated here.

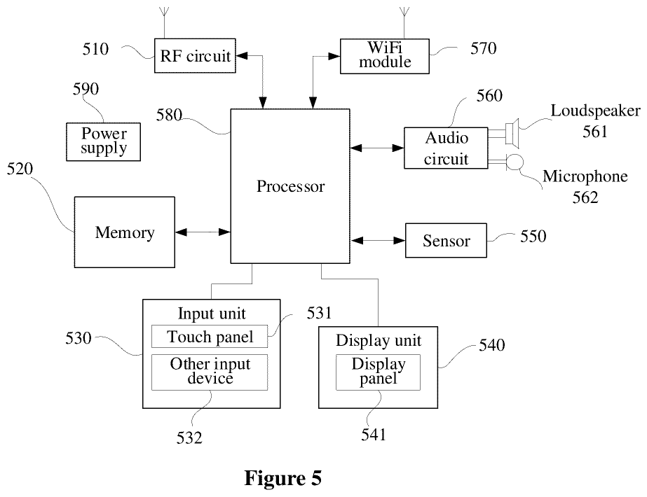

In a case that the pitch adjustment apparatus is a terminal, the structural diagram is as shown in FIG. 5. Referring to FIG. 5, a pitch adjustment apparatus according to an embodiment of the present disclosure is shown.

For ease of description, only the parts related to the embodiments of the present disclosure are shown. For specific technical details not described, reference may be made to the corresponding part of the method embodiments of the present disclosure. The terminal may be any terminal device including a mobile phone, a tablet computer, a Personal Digital Assistant (PDA), a Point of Sales (POS), a vehicle-mounted computer, etc. The following are described by taking the terminal of a mobile phone as an example.

FIG. 5 shows a block diagram of a partial structure of a mobile phone related to the terminal according to the embodiment of the present disclosure. Referring to FIG. 5, the mobile phone includes: a radio frequency (RF) circuit 510, a memory 520, an input unit 530, a display unit 540, a sensor 550, an audio circuit 560, a wireless fidelity (WiFi) module 570, a processor 580, a power supply 590 and the like. Those skilled in the art may understand that the structure of the mobile phone shown in FIG. 5 is not limited to the mobile phone, and may include more or less components than shown in FIG. 5, or combine some components, or have different component arrangement.

Next, the components of the mobile phone is described in detail in the following with reference to FIG. 5.

The RF circuit 510 may be used for sending and receiving signals during information receiving and sending or during a call. In particular, the RF circuit 510 may receive the downlink information from the base station and send it to the processor 580 for processing. In addition, the RF circuit 510 may send the uplink data to the base station. Generally, the RF circuit 510 includes, but is not limited to, an antenna, at least one amplifier, a transceiver, a coupler, a low noise amplifier (LNA), a duplexer, and the like. In addition, the RF circuitry 510 may also communicate with networks and other devices via wireless communications. The above wireless communication may use any communication standard or protocol, including but not limited to Global System of Mobile Communication (GSM), General Packet Radio Service (GPRS), Code Division Multiple Access (CDMA), Wideband Code Division Multiple Access (WCDMA), Long Term Evolution (LTE), email, Short Messaging Service (SMS), etc.

The memory 520 may be used to store software programs and modules, and the processor 580 executes various functional applications and data processing of the mobile phone by running the software programs and modules stored in the memory 520. The memory 520 may mainly include a program storage area and a data storage area. The program storage area may store an operating system, application programs required by at least one function (for example, a sound playback function, an image playback function). The data storage area may store data created by the use of the mobile phone (for example, audio data, a phonebook). In addition, the memory 520 may include a high-speed random-access memory, and may also include a non-volatile memory, such as at least one magnetic disk storage device, flash memory device, or other volatile solid-state storage devices.

The input unit 530 may be used to receive input numbers or character information, and generate key signal input related to user settings and function control of the mobile phone. Specifically, the input unit 530 may include a touch panel 531 and other input devices 532. The touch panel 531, also referred to as a touch screen, may collect touch operations of the user on or near it (for example, operations of the user on or near the touch panel 531 by using any suitable object or accessory such as a finger or a stylus), and drive the corresponding connection device according to the preset program. Optionally, the touch panel 531 may include two parts, that is, a touch detection device and a touch controller. The touch detection device detects the touch orientation of the user, and detects the signal caused by the touch operation, and transmits the signal to the touch controller. The touch controller receives the touch information from the touch detection device, converts the touch information into a contact coordinate, and sends the contact coordinate to the processor 580, and may receive and execute commands sent by the processor 580. In addition, the touch panel 531 may be implemented in various types such as resistive, capacitive, infrared, and surface acoustic wave. In addition to the touch panel 531, the input unit 530 may also include other input devices 532. Specifically, other input devices 532 may include but not limited to one or more of a physical keyboard, a function key (for example, a volume control key, a switch key), a trackball, a mouse, a joystick, and the like.

The display unit 540 may be used to display information input by or provided to the user and various menus of the mobile phone. The display unit 540 may include a display panel 541, and optionally, the display panel 541 may be configured in the form of a liquid crystal display (LCD), an organic light-emitting diode (OLED), or the like. Further, the touch panel 531 may cover the display panel 541, and when detecting a touch operation on or near it, the touch panel 531 transmits the touch operation to the processor 580 to determine the type of the touch event, and the processor 580 provides a corresponding visual output on the display panel 541 according to the type of the touch event. Although in FIG. 5, the touch panel 531 and the display panel 541 are shown as two independent components to realize the input and input functions of the mobile phone, in some embodiments, the touch panel 531 and the display panel 541 may be integrated to realize the input and output functions of the mobile phone.

The mobile phone may also include at least one sensor 550, such as a light sensor, a motion sensor, and other sensors. Specifically, the light sensor may include an ambient light sensor and a proximity sensor, where the ambient light sensor may adjust the brightness of the display panel 541 according to the brightness of the ambient light, and the proximity sensor may turn off the display panel 541 and/or backlight when the mobile phone is moved to the ear. As a kind of motion sensor, the accelerometer sensor may detect the magnitude of acceleration in various directions (generally along three axes), and may detect the magnitude and direction of gravity when it is stationary, and may be used for applications that recognize the posture of the mobile phone (such as horizontal and vertical screen switching, related games, magnetometer attitude calibration), vibration recognition related functions (such as pedometer, tap), etc. For other sensors such as a gyroscope, a barometer, a hygrometer, a thermometer, an infrared sensor that may be provided on the mobile phone, description is not repeated here.

The audio circuit 560, the speaker 561, and the microphone 562 may provide an audio interface between the user and the mobile phone. The audio circuit 560 may transmit the electrical signal converted from the received audio data to the loudspeaker 561, and the loudspeaker 561 converts the electrical signal into an audio signal to output. In addition, the microphone 562 converts the collected sound signal into the electrical signal, and the audio circuit 560 receives and converts the electrical signal into audio data, and outputs the audio data to the processor 580 for processing, and then the processor sends the processed audio data to another mobile phone through the RF circuit 510, or outputs the audio data to the memory 520 for further processing.

WiFi is a short-distance wireless transmission technology. The mobile phone may help users send and receive emails, browse web pages, and access streaming media through the WiFi module 570, which provides users with wireless broadband Internet access. Although FIG. 5 shows a WiFi module 570, it is to be understood that the WiFi module 570 is not an essential component of the mobile phone.

The processor 580 is a control center of the mobile phone, which uses various interfaces and lines to connect various parts of the entire mobile phone. By running or executing software programs and/or modules stored in the memory 520, and calling data stored in the memory 520, the processor 580 may execute various functions of the mobile phone and processing data, so as to monitor the mobile phone as a whole. Optionally, the processor 580 may include one or more processing units. Preferably, the processor 580 may integrate an application processor and a modem processor, where the application processor mainly processes operating systems, user interfaces, and application programs, etc., the modem processor mainly processes wireless communications. It is to be understood that the foregoing modem processor may not be integrated into the processor 580.

The mobile phone further includes a power supply 590 (such as a battery) for supplying power to various components. Preferably, the power supply may be logically connected to the processor 580 through the power management system, so that functions such as charging, discharging, and power consumption management may be realized through the power management system.

Although not shown, the mobile phone may further include a camera, a Bluetooth module, etc., which will not be repeated here.

In the embodiment of the present disclosure, the processor 580 included in the terminal may execute the functions in the foregoing embodiments shown in FIG. 1 to FIG. 2, which will not be repeated here.

A computer storage medium is further provided according to an embodiment of the present disclosure, which stores instructions, and the instructions, when executed on a computer, cause the computer to execute the operations performed by the pitch adjustment apparatus in above-mentioned embodiments shown in FIG. 1 to FIG. 2.

Those skilled in the art may clearly understand that for the convenience and brevity of the description, the specific working process of the above-described system, device and unit may refer to the corresponding process in the foregoing method embodiment, which will not be repeated here.

In the several embodiments provided in the present disclosure, it is to be understood that the disclosed system, apparatus and method may be implemented in other ways. For example, the apparatus embodiments described above are only illustrative. For example, the division of the units is only a logical function division. In practice, there may be other division methods. For example, multiple units or components may be combined or may be integrated into another system, or some features may be omitted, or not implemented. In another aspect, the mutual coupling or direct coupling or communication connection shown or discussed may be implemented through some interfaces, and the indirect coupling or communication connection of devices or units may be implemented in electrical, mechanical or other forms.

The units described as separate components may or may not be physically separated, and the components shown as units may or may not be physical units, that is, they may be located in one place, or may be distributed to multiple network units. Part or all of the units may be selected according to actual needs to achieve the purpose of the solution of this embodiment.

In addition, each functional unit in each embodiment of the present disclosure may be integrated into one processing unit, or each unit may exist separately physically, or two or more units may be integrated into one unit. The above-mentioned integrated units may be implemented in the form of hardware or in the form of software functional unit.

If the integrated unit is implemented in the form of a software function unit and sold or used as an independent product, it may be stored in a computer-readable storage medium. Based on this understanding, the technical solution of the present disclosure is essentially or part of the technical solution that make contribution to the prior art or all or part of the technical solution may be embodied in the form of a software product, and the computer software product is stored in a storage medium, including several instructions for enabling a computer device (which may be a personal computer, a server, or a network device, etc.) to execute all or part of the steps of the method described in the various embodiments of the present disclosure. The aforementioned storage medium include: a U disk, a mobile hard disk, a read-only memory (ROM), a random access memory (RAM), a magnetic disk or an optical disk, and other medium that may store program codes.

1. A pitch adjustment method, comprising:
obtaining a plurality of candidate melody files, each of the plurality of candidate melody files is used to identify a pitch of each note in a melody of a target song, and pitches identified by the plurality of candidate melody files are different from each other;
obtaining a fundamental frequency sequence of a singing sound of a user for singing the target song, and converting a frequency at a target fundamental frequency point of the fundamental frequency sequence into a pitch according to a preset algorithm, wherein the target fundamental frequency point comprises a fundamental frequency point corresponding to the note of the candidate melody file in time in the fundamental frequency sequence;
calculating, for each of the plurality of candidate melody files, a pitch difference between the candidate melody file and the fundamental frequency sequence at each corresponding time point, and calculating, for each of the plurality of candidate melody files, a sum of all pitch differences of the candidate melody file; and
determining a candidate melody file with a minimum sum as a target melody file, and adjusting a pitch of an accompaniment file of the target song according to a pitch difference between the target melody file and an original melody file of the target song.

2. The pitch adjustment method according to claim 1, wherein the obtaining a plurality of candidate melody files comprises:
obtaining the original melody file of the target song;
adding a conversion value to a pitch of each note in the original melody file to obtain a converted melody file; and
determining the original melody file and the converted melody file as the candidate melody files.

3. The pitch adjustment method according to claim 2, wherein the adding a conversion values to a pitch of each note in the original melody file to obtain a converted melody file comprises:
equally dividing, based on the 12-equal temperament, an octave corresponding to the original melody file to obtain twelve semitone intervals, and the original melody file corresponds to one of the twelve semitone intervals; and
adding, based on an interval relationship between the semitone interval corresponding to the original melody file and other semitone intervals, the conversion value to the pitch of each note in the original melody file until the adding is performed for eleven number of times, to obtain eleven converted melody files, wherein
each of the converted melody files corresponds to one of the twelve semitone intervals.

4. The pitch adjustment method according to claim 3, wherein in a case that the target melody file is not the original melody file, the adjusting a pitch of an accompaniment file of the target song according to a pitch difference between the target melody file and an original melody file of the target song comprises:
adjusting the pitch of the accompaniment file of the target song according to the interval relationship between the target melody file and the original melody file.

5. The pitch adjustment method according to claim 1, wherein after the determining a candidate melody file with a minimum sum as a target melody file, the method further comprises:
determining whether a proportion of notes with a pitch difference of 0 among all notes in the target melody file is greater than a preset threshold, wherein
if the proportion of the notes with the pitch difference of 0 among all notes in the target melody file is greater than the preset threshold, the step of adjusting a pitch of an accompaniment file of the target song according to a pitch difference between the target melody file and an original melody file of the target song is performed; and
if the proportion of the notes with the pitch difference of 0 among all notes in the target melody file is not greater than the preset threshold, the pitch of the accompaniment file is not adjusted.

6. The pitch adjustment method according to claim 1, wherein the converting a frequency at a target fundamental frequency point of the fundamental frequency sequence into a pitch according to a preset algorithm comprises:
determining, in the fundamental frequency sequence, the target fundamental frequency point corresponding to the note of the candidate melody file in time; and
converting the frequency at the target fundamental frequency point into a pitch according to the preset algorithm, and wherein
the calculating, for each of the plurality of candidate melody files, a pitch difference between the candidate melody file and the fundamental frequency sequence at each corresponding time point comprises:
obtaining, for each of the candidate melody files, a pitch of a note in the candidate melody file corresponding to the target fundamental frequency point in time, and calculating a pitch difference between the target fundamental frequency point and the note corresponding to the target fundamental frequency point in time.

7. The pitch adjustment method according to claim 6, wherein each of the candidate melody files is further used to identify a start time and an end time of each note in a melody of the target song, and
the obtaining, for each of the candidate melody files, a pitch of a note in the candidate melody file corresponding to the target fundamental frequency point in time comprises:
determining the note corresponding to the target fundamental frequency point in time according to the start time and the end time of each note in each of the candidate melody files; and
obtaining a pitch of the note corresponding to the target fundamental frequency point in time.

8-9. (canceled)

10. A pitch adjustment apparatus, comprising:
a processor, a memory, a bus, input and output device, wherein
the processor is connected to the memory and the input and output device;
the bus is connected to the processor, the memory and the input and output device; and
the processor is configured to:
obtain a plurality of candidate melody files, each of the plurality of candidate melody files is used to identify a pitch of each note in a melody of a target song, and pitches identified by the plurality of candidate melody files are different from each other;
obtain a fundamental frequency sequence of a singing sound of a user for singing the target song, and convert a frequency at a target fundamental frequency point of the fundamental frequency sequence into a pitch according to a preset algorithm, wherein the target fundamental frequency point comprises a fundamental frequency point corresponding to the note of the candidate melody file in time in the fundamental frequency sequence;
calculate, for each of the plurality of candidate melody files, a pitch difference between the candidate melody file and the fundamental frequency sequence at each corresponding time point, and calculate, for each of the plurality of candidate melody files, a sum of all pitch differences of the candidate melody file; and
determine a candidate melody file with a minimum sum as a target melody file, and adjusting a pitch of an accompaniment file of the target song according to a pitch difference between the target melody file and an original melody file of the target song.

11. A non-transient computer storage medium, comprising instructions stored thereon, wherein the instructions, when executed on a computer, cause the computer to execute a pitch adjustment method, and the pitch adjustment method comprises:
obtaining a plurality of candidate melody files, each of the plurality of candidate melody files is used to identify a pitch of each note in a melody of a target song, and pitches identified by the plurality of candidate melody files are different from each other;
obtaining a fundamental frequency sequence of a singing sound of a user for singing the target song, and converting a frequency at a target fundamental frequency point of the fundamental frequency sequence into a pitch according to a preset algorithm, wherein the target fundamental frequency point comprises a fundamental frequency point corresponding to the note of the candidate melody file in time in the fundamental frequency sequence;
calculating, for each of the plurality of candidate melody files, a pitch difference between the candidate melody file and the fundamental frequency sequence at each corresponding time point, and calculating, for each of the plurality of candidate melody files, a sum of all pitch differences of the candidate melody file; and
determining a candidate melody file with a minimum sum as a target melody file, and adjusting a pitch of an accompaniment file of the target song according to a pitch difference between the target melody file and an original melody file of the target song.

12. The pitch adjustment apparatus according to claim 10, wherein to obtain a plurality of candidate melody files, the processor is further configured to:
obtain the original melody file of the target song;
add a conversion value to a pitch of each note in the original melody file to obtain a converted melody file; and
determine the original melody file and the converted melody file as the candidate melody files.

13. The pitch adjustment apparatus according to claim 12, wherein to add a conversion values to a pitch of each note in the original melody file to obtain a converted melody file, the processor is further configured to:
equally divide, based on the 12-equal temperament, an octave corresponding to the original melody file to obtain twelve semitone intervals, and the original melody file corresponds to one of the twelve semitone intervals; and
add, based on an interval relationship between the semitone interval corresponding to the original melody file and other semitone intervals, the conversion value to the pitch of each note in the original melody file until the adding is performed for eleven number of times, to obtain eleven converted melody files, wherein
each of the converted melody files corresponds to one of the twelve semitone intervals.

14. The pitch adjustment apparatus according to claim 13, wherein in a case that the target melody file is not the original melody file, to adjust a pitch of an accompaniment file of the target song according to a pitch difference between the target melody file and an original melody file of the target song, the processor is further configured to:
adjust the pitch of the accompaniment file of the target song according to the interval relationship between the target melody file and the original melody file.

15. The pitch adjustment apparatus according to claim 10, wherein after determining a candidate melody file with a minimum sum as a target melody file, the processor is further configured to:
determine whether a proportion of notes with a pitch difference of 0 among all notes in the target melody file is greater than a preset threshold, wherein
if the proportion of the notes with the pitch difference of 0 among all notes in the target melody file is greater than the preset threshold, a step of adjusting a pitch of an accompaniment file of the target song according to a pitch difference between the target melody file and an original melody file of the target song is performed; and
if the proportion of the notes with the pitch difference of 0 among all notes in the target melody file is not greater than the preset threshold, the pitch of the accompaniment file is not adjusted.

16. The pitch adjustment apparatus according to claim 10, wherein to convert a frequency at a target fundamental frequency point of the fundamental frequency sequence into a pitch according to a preset algorithm, the processor is further configured to:
determine, in the fundamental frequency sequence, the target fundamental frequency point corresponding to the note of the candidate melody file in time; and
convert the frequency at the target fundamental frequency point into a pitch according to the preset algorithm, and wherein
to calculate, for each of the plurality of candidate melody files, a pitch difference between the candidate melody file and the fundamental frequency sequence at each corresponding time point, the processor is further configured to:
obtain, for each of the candidate melody files, a pitch of a note in the candidate melody file corresponding to the target fundamental frequency point in time, and calculate a pitch difference between the target fundamental frequency point and the note corresponding to the target fundamental frequency point in time.

17. The pitch adjustment apparatus according to claim 16, wherein each of the candidate melody files is further used to identify a start time and an end time of each note in a melody of the target song, and
to obtain, for each of the candidate melody files, a pitch of a note in the candidate melody file corresponding to the target fundamental frequency point in time, the processor is further configured to:
determine the note corresponding to the target fundamental frequency point in time
according to the start time and the end time of each note in each of the candidate melody files; and
obtain a pitch of the note corresponding to the target fundamental frequency point in time.
